(19) United States
(12) Patent Application Publication
(10) Pub. No.: US 2008/0007632 A1
(43) Pub. Date: Jan. 10, 2008

(54) Electronic card storage device

(76) Inventor: Chuan-Hui Liao, Sinjhuang City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/481,647

(22) Filed: Jul. 6, 2006

(51) Int. Cl. H04N 5/76

(52) U.S. Cl. 348/231.7

(57) ABSTRACT

An electronic card storage device includes a central processing unit, a digital camera, a storage memory, a wireless transceiver unit, and a display unit. Thus, the electronic card storage device is connected to the computer to have an expansion function, so that the information of the card is interchanged and edited between the electronic card storage device and the computer. In addition, the digital camera has a fixed focal length so that the digital camera photographs the information on a card in a near photographing manner without having to adjust the focal length so as to read the information of the card exactly in an easy and stable manner without producing errors.

### BACKGROUND OF THE INVENTION

1. Field of the Invention

The present invention relates to a card storage device and, more particularly, to an electronic card storage device.

2. Description of the Related Art

A conventional electronic card storage device comprises a scanner to scan the information of a card to obtain an image information, a transmission module to input the image information into a processing unit which processes and stores the information, and a display to indicate the information.

However, the information is transmitted between the processing unit and the display in a wire manner, and the electronic card storage device needs to have a determined volume to receive the circuit board, the power supply, the switch, so that the size of the display is limited, and the memory capacity is also limited. In addition, the scanner cannot scan and read the information of the card exactly and stably, so that the image information transmitted into the transmission module easily produces errors.

### BRIEF SUMMARY OF THE INVENTION

In accordance with the present invention, there is provided an electronic card storage device, comprising a central processing unit including an editor and a sorter, a digital camera connected to the central processing unit, a storage memory connected to the central processing unit, a wireless transceiver unit connected to the storage memory, and a display unit connected to the digital camera.

The primary objective of the present invention is to provide an electronic card storage device, wherein the electronic card storage device is connected to the computer to have an expansion function, so that the information of the card is interchanged and edited between the electronic card storage device and the computer, thereby enhancing the versatility of the electronic card storage device.

Another objective of the present invention is to provide an electronic card storage device, wherein the digital camera has a fixed focal length so that the digital camera photographs the information on a card in a near photographing manner without having to adjust the focal length so as to read the information of the card exactly in an easy and stable manner without producing errors.

A further objective of the present invention is to provide an electronic card storage device, wherein the digital camera has a fixed focal length and needs not to be expanded or contracted to adjust the focal length so that the electronic card storage device has a smaller volume, thereby facilitating packaging, storage and transportation of the electronic card storage device.

A further objective of the present invention is to provide an electronic card storage device, wherein the electronic card storage device has a smaller volume, so that the electronic card storage device is portable, thereby facilitating the user carrying the electronic card storage device.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an electronic card storage device in accordance with the preferred embodiment of the present invention.

FIG. 2 is another perspective view of the electronic card storage device as shown in FIG. 1.

FIG. 3 is a block diagram of the electronic card storage device as shown in FIG. 1.

FIG. 4 is a schematic perspective view showing usage of the electronic card storage device as shown in FIG. 1.

### DETAILED DESCRIPTION OF THE INVENTION

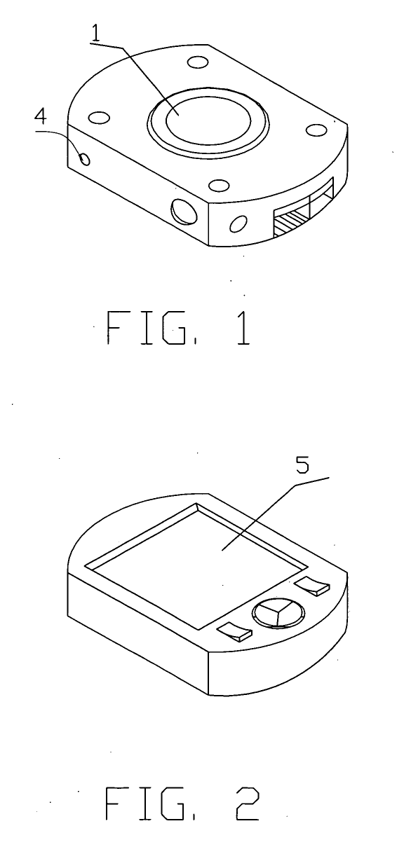

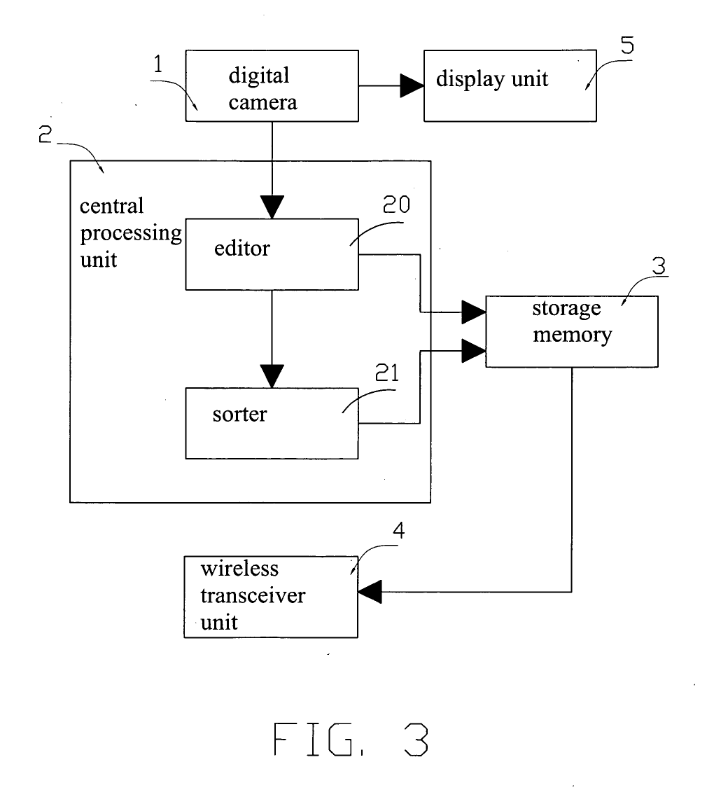

Referring to the drawings and initially to FIGS. 1-3, an electronic card storage device in accordance with the preferred embodiment of the present invention comprises a central processing unit 2 including an editor (or compiler) 20 and a sorter (or classifier) 21, a digital camera 1 connected to the central processing unit 2, a storage memory 3 connected to the central processing unit 2, a wireless transceiver unit 4 connected to the storage memory 3, and a display unit 5 connected to the digital camera 1.

The digital camera 1 contains about three hundred thousand to three million (300,000 to 3,000,000) pixels and has a fixed focal length so that the focal length of the digital camera 1 needs not to be adjusted. Thus, the digital camera 1 photographs and reads the information on a card in a near photographing manner without having to adjust its focal length.

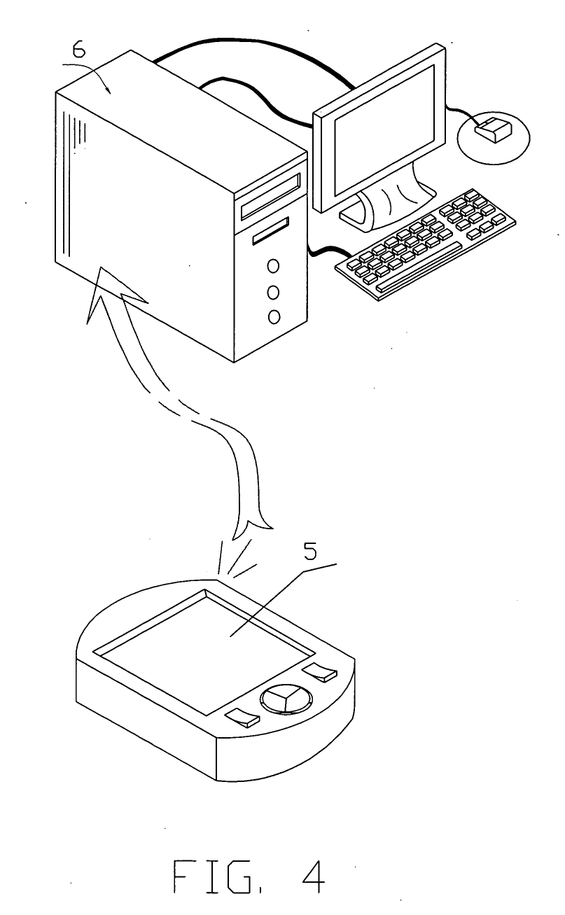

The central processing unit 2 is connected to a computer 6 (see FIG. 4) by a USB or SD. The editor 20 of the central processing unit 2 edits the information from the digital camera 1, and the sorter 21 of the central processing unit 2 sorts the information from the digital camera 1.

The storage memory 3 is used to store the information from the editor 20 and the sorter 21 of the central processing unit 2. Preferably, the storage memory 3 is a memory card. In addition, the information from the editor 20 and the sorter 21 of the central processing unit 2 can be stored in the hard disk of the computer 6.

The wireless transceiver unit 4 is used to receive and transmit the information of the central processing unit 2 to the computer 6 in a far infrared wireless transmission manner by a blue tooth technology.

The display unit 5 has a large-scale monitor to display the information.

In operation, referring to FIGS. 1-4, the editor 20 of the central processing unit 2 edits the information from the digital camera 1, the sorter 21 of the central processing unit 2 sorts the information from the digital camera 1, and the storage memory 3 is used to store the information from the editor 20 and the sorter 21 of the central processing unit 2. Alternatively, the information of the central processing unit 2 is transmitted to the computer 6 by the wireless transceiver unit 4. Thus, the information from the digital camera 1 can be edited and stored in the electronic card storage device and can also be edited in the computer 6.

Accordingly, the electronic card storage device is connected to the computer 6 to have an expansion function, so that the information of the card is interchanged and edited between the electronic card storage device and the computer 6, thereby enhancing the versatility of the electronic card storage device. In addition, the digital camera 1 has a fixed focal length so that the digital camera 1 photographs the information on a card in a near photographing manner without having to adjust the focal length so as to read the information of the card exactly in an easy and stable manner without producing errors. Further, the digital camera 1 has a fixed focal length and needs not to be expanded or contracted to adjust the focal length so that the electronic card storage device has a smaller volume, thereby facilitating packaging, storage and transportation of the electronic card storage device. Further, the electronic card storage device has a smaller volume, so that the electronic card storage device is portable conveniently, thereby facilitating the user carrying the electronic card storage device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An electronic card storage device, comprising:
a central processing unit including an editor and a sorter;
a digital camera connected to the central processing unit;
a storage memory connected to the central processing unit;
a wireless transceiver unit connected to the storage memory;
a display unit connected to the digital camera.

2. The electronic card storage device in accordance with claim 1, wherein the digital camera has a fixed focal length and needs not to be expanded or contracted to adjust the focal length

3. The electronic card storage device in accordance with claim 1, wherein the digital camera photographs and reads an information on a card in a near photographing manner.

4. The electronic card storage device in accordance with claim 1, wherein the central processing unit is connected to a computer.

5. The electronic card storage device in accordance with claim 1, wherein the editor of the central processing unit edits the information from the digital camera, and the sorter of the central processing unit sorts the information from the digital camera.

6. The electronic card storage device in accordance with claim 5, wherein the storage memory stores the information from the editor and the sorter of the central processing unit.

7. The electronic card storage device in accordance with claim 1, wherein the wireless transceiver unit receives and transmits an information of the central processing unit to a computer in a far infrared wireless transmission manner by a blue tooth technology.

8. The electronic card storage device in accordance with claim 7, wherein an information from the digital camera is edited and stored in the electronic card storage device or edited in the computer.

9. The electronic card storage device in accordance with claim 1, wherein the display unit has a large-scale monitor to display an information.

10. The electronic card storage device in accordance with claim 1, wherein the electronic card storage device is connected to a computer to have an expansion function, so that an information of the card is interchanged and edited between the electronic card storage device and the computer.
